(19) United States
(12) Patent Application Publication
(10) Pub. No.: US 2021/0202121 A1
(43) Pub. Date: Jul. 1, 2021

(54) Flow Mixing T-Unit of Reactor Volume Control System

(71) Applicants: Joint-Stock Company Scientific Research and Design Institute for Energy Technologies ATOMPROEKT, St. Petersburg (RU); Joint Stock Company "Science and Innovations", Moscow (RU)

(72) Inventors: Vladimir Victorovich BEZLEPKIN, St. Petersburg (RU); Alexey Ivanovich KURCHEVSKIY, St. Petersburg (RU); Vladimir Olegovich KUKHTEVICH, St. Petersburg (RU); Andrey Gennad'evich MITRYUKHIN, St. Petersburg (RU); Maksim Yur'evich KROPOTOV, St. Petersburg (RU)

(21) Appl. No.: 16/089,829

(22) PCT Filed: Jun. 30, 2017
(86) PCT No.: PCT/RU2017/000470

§ 371 Date: Sep. 28, 2018

(51) Int. Cl. G21C 15/22; F16L 41/02; F16L 9/18

(52) U.S. Cl. CPC G21C 15/22; F16L 9/18; F16L 41/021

(57) ABSTRACT

Primary circuit auxiliary systems. The invention provides integrity and normal operation of the T-unit, including cases when the unit operates under abnormal conditions. The flow mixing T-unit of reactor volume control system which includes a T-piece connected with two ends to the bypass line carrying the coolant of one temperature, and with the additional opening to the makeup system pipeline carrying the coolant of a different temperature under emergency and an insert which separates the coolant flows of different temperature, the insert is installed upstream the coolant flow in the bypass so that its outer part is located upstream the coolant inlet into the T-unit, and its inner part is cantilevered inside the T-unit and forms a tube with openings in the area of the T-piece. The T-unit is provided with an adapter mounted at its outlet and forming, together with the insert, a coaxial channel for coolant flow.

### CROSS-REFERENCE TO RELATED APPLICATIONS

This application is a US 371 application from PCT/RU2017/000470 filed Jun. 30, 2017, the technical disclosures of which are hereby incorporated herein by reference.

The invention relates to nuclear power industry, and more particularly, to primary circuit auxiliary systems and can be utilized in water-cooled water-moderated power reactors (VVER).

Modern VVER NPPs use two-circuit configurations with generation of saturated or slightly superheated steam, with stream separation and resuperheating upstream the turbine. The pressure level of steam generated in the steam generator depends on the allowable heating of the coolant in the reactor and is 6-7 MPa.

The primary circuit of the plant is designed to remove the heat released in the reactor and transfer it to the secondary circuit in the steam generator. Apart from the reactor, steam generators, reactor coolant pumps (RCP) and reactor coolant pipelines, the primary circuit includes a pressurizing system and a primary circuit purification system operating at primary circuit pressure. To provide operation of the primary circuit the following auxiliary systems are in place: circuit makeup and purification system, gas blow-offs system, controlled leakage system, special water treatment drainage system, etc.

The primary makeup system provides makeup water supply to the reactor coolant circuit to maintain the preset level of coolant in the pressurizer. The system returns the water taken from the circuit for treatment, provides filling of the primary circuit with water, maintains pressure in the primary circuit in emergency modes resulting from pressure drop (pipeline rupture, NPP blackout etc.), compensates for the flow of controlled leaks from the circuit, as well as minor emergency leaks.

Generally, the volume control system of the primary circuit consists of a makeup pump, regenerative heat exchanger, blowdown water after-cooler, throttling device and special water treatment equipment. (SU No. 990000 1981)

The main problem of such systems is the occurrence of large temperature differences and stresses in the metal of makeup nozzles, which results from high temperature difference of the mixing flows, causing loss of strength and failure of equipment. To prevent this, a bypass pipeline is added to the system, one of its ends is connected to the makeup nozzle, and the other one to the blowdown nozzle.

T-connection is a widely used branch for piping connections in various systems of VVER reactor plants.

Heat exchange processes in various components of power-generating equipment of such plants (boiler pipes, steam generators and other heat exchangers, fuel elements and other structural elements of reactors, CPS drive units, pipeline elements, etc.) are characterized by temperature fluctuations.

Features of such fluctuations depend on many factors. Most intense fluctuations occur during nucleate and film boiling, unstable “steaming” of the heating surfaces, moisture carry-over onto heated surfaces, flow stratification, fluctuations in flow of coolants, natural convection, etc. Temperature fluctuations cause corresponding (sometimes significant) fluctuations in temperature stresses, which, when added to steady-state loads combined with the corrosive impact of the medium, may lead to fatigue or corrosive failure of components.

If temperatures are high and change relatively slowly, additional temperature stresses may be avoided. However, even in such case, temperature fluctuations cause acceleration of destruction process under creep conditions.

Mixing of coolants with high temperature difference or unsteady natural convection results in pipeline damage.

There are known solutions to improve safety and reliability of T-connections that reduce thermal stresses and deformation through use of ceramic insulation on one of the nozzles. (U.S. Pat. No. 5,575,423 1994) However, this device can not be used in nuclear reactors as it does not comply with the requirements for T-unit strength due to a high difference in temperatures of the mixing flows.

The closest to the proposed solution is the flow mixing T-unit of reactor volume control system which includes a T-piece connected with two ends to the main pipeline carrying the coolant of one temperature, and with the additional opening to the auxiliary pipeline of the system carrying the coolant of a different temperature, and an insert which separates the coolant flows of different temperature. (US No. 2014/0334594 2012).

In such a unit, the insert separating the coolant flows creates significant temperature gradient at the junction of the auxiliary and main pipelines, which reduces the T-connection reliability, as temperature deformations of the pipelines and lateral branch result in major stresses that may exceed the strength properties of the T-piece material.

As referenced above, the main requirement for the emergency protection system during design, analysis and operation of a nuclear reactor is that the protection system shall ensure safety in the event of a loss-of-coolant accident (maximum design-basis accident). Any unexpected loss of coolant flow through the reactor core may have serious consequences for the nuclear power plant as a whole. Loss of flow may result from a failure of a reactor coolant pump or a valve or from a rupture of the main pipeline at the reactor pressure vessel inlet or outlet.

The coolant temperature in the makeup pipeline can be 20° C., and in the bypass, up to 300° C., which may cause T-unit failure to comply with strength criteria due to high temperature difference of the mixing flows.

The purpose of the invention is to ensure the integrity and normal operation of the T-unit.

The technical result to be achieved is improvement of T-connection reliability by retention of its strength through reduction of high- and low-frequency temperature fluctuations and the associated cyclic stresses.

To solve the above-mentioned problem and achieve the indicated technical result the flow mixing T-unit of reactor volume control system which includes a T-piece connected with two ends to the bypass line carrying the coolant of one temperature, and with the additional opening to the auxiliary pipeline of the system carrying the coolant of a different temperature under emergency, and an insert which separates the coolant flows of different temperature:

the insert is installed in the coolant flow to the bypass in such a way that its outer part is upstream the coolant inlet into the T-unit,

its inner part (cantilevered inside the T-unit) forms a tube with openings in the area of the T-piece,

T-unit is provided with an adapter mounted at its outlet end and forming together with the insert a coaxial channel for coolant flow.

The inner surface of the outer part of the insert shall be preferably designed as a reducer.

The openings in the insert tube shall be preferably elliptically shaped.

The insert is installed upstream the coolant flow in the bypass so that its outer part is located upstream the coolant inlet into the T-unit, and its inner part is cantilevered inside the T-unit and forms a tube with openings in the area of the T-piece; T-unit is provided with an adapter mounted at its outlet and forming together with the insert a coaxial channel for coolant flow. The above features allow to ensure the integrity and normal operation of the T-unit when its operational conditions are disturbed due to retention of its strength by reducing high- and low-frequency temperature fluctuations and associated cyclic stresses.

The mixing of flows with different temperatures is enhanced as the inner surface of the outer part of the insert is shaped as a reducer and the openings in the insert tube are elliptically shaped.

T-unit operation is described below and illustrated by the drawings attached to the application.

The drawings show the flow mixing T-unit of reactor volume control system, where

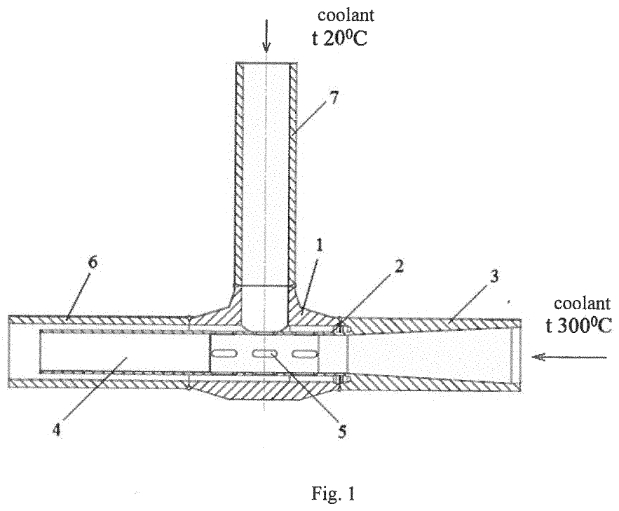

FIG. 1 shows the unit as an assembly,

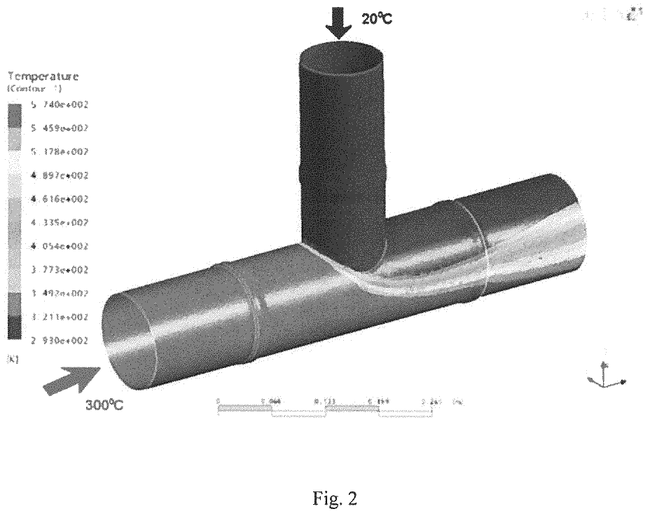

FIG. 2 shows the distribution of the temperature field over the surface of a standard T-unit, and

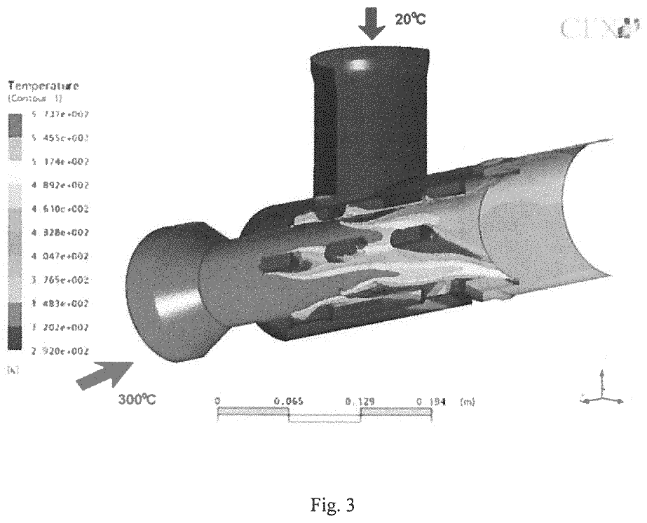

FIG. 3 shows the distribution of temperature field over the surface of the T-unit proposed.

As shown in FIG. 1, the flow mixing T-unit of reactor volume control system comprises a T-piece (1), an insert (2), the outer part (3) of which is connected to the bypass pipeline carrying hot coolant flow (not shown in the drawing), and the inner part (4) is located inside the T-piece and has openings (5). The unit is provided with an adapter (6) mounted between the T-piece (1) and the bypass pipeline for removal of hot coolant (not shown in the drawing). The makeup pipeline (7), which carries cold coolant flow under emergencies, is connected to the additional opening of the T-piece.

During operation, water is taken from the reactor coolant pipeline, it flows to the regenerative heat exchanger, heats the makeup water; and the makeup water flows to the RCP. If the heat exchanger operates in the normal mode, there will be no problems with the T-unit since the makeup water temperature is comparable with the temperature of water in the bypass and, therefore, no temperature stress is produced.

In the event of an accident, the makeup water ceases to get heated, and when entering the RCP branch (via the makeup pipeline) it produces a temperature gradient in the heat exchanger and, consequently, creates temperature stresses in the T-piece. In addition, a decrease in the makeup water temperature is also possible in different, not only emergency, operating modes of the reactor plant including loss of power and spurious actuation of the reactor emergency protection system.

In this case the cold makeup water gets into the T-piece (1) via the makeup pipeline (7) and then to the coaxial channel between the adapter (6) and the insert (4), and after it gets partially mixed with the hot water coming through the reducer of the outer part (3) of the insert (2) from the bypass, gets finally mixed with the flow entering through the openings (5) in the insert (2) tube. This results in rapid heat exchange between the cold makeup water and hot water entering from the bypass, which ensures equalization of temperatures of the flow passing through the T-piece as shown in FIG. 3.

Therefore, use of the insert 2 in the T-unit ensures mixing of hot and cold coolant without generating significant temperature gradients at the makeup and bypass pipelines connection. In addition, the effect of relatively high temperature gradients falls on the insert (2), the failure of which does not pose such a threat as T-piece (1) destruction and can be easily rectified by replacing the insert (2) with a new one.

Numerous studies and calculations carried out by the authors have shown (see FIG. 2 and FIG. 3) that the proposed design makes it possible to ensure the integrity and normal operation of the T-unit in case of its abnormal operation due to retention of its integrity by reducing high- and low-frequency temperature fluctuations and related cyclic stresses.

1. Flow mixing T-unit of reactor volume control system which includes a T-piece connected with two ends to the bypass line carrying the coolant of one temperature, and with the additional opening to the makeup system pipeline carrying the coolant of a different temperature under emergency and an insert which separates the coolant flows of different temperature: wherein the insert is installed upstream the coolant flow in the bypass so that its outer part is located upstream the coolant inlet into the T-unit, and its inner part is cantilevered inside the T-unit and forms a tube with openings in the area of the T-piece. The T-unit is provided with an adapter mounted at its outlet and forming, together with the insert, a coaxial channel for coolant flow.

2. A T-unit as defined in claim 1, wherein the inner surface of the outer part of the insert is shaped as a reducer.

3. A T-unit as defined in claim 1, wherein the openings in the insert tube are elliptically shaped.
